(19) United States
(12) Patent Application Publication
(10) Pub. No.: US 2013/0108930 A1
(43) Pub. Date: May 2, 2013

(54) PERFORMANCE ENHANCEMENT ADDITIVES FOR DISORDERED CARBON ANODES

(71) Applicant: Enerdel, Inc., Indianapolis, IN (US)

(72) Inventors: Mary L. Patterson, Carmel, IN (US); Mark A. Balicki, Fishers, IN (US); Mohamed Taggougui, Fishers, IN (US)

(73) Assignee: ENERDEL, INC., Indianapolis, IN (US)

(21) Appl. No.: 13/660,667

(22) Filed: Oct. 25, 2012

Related U.S. Application Data
(60) Provisional application No. 61/552,620, filed on Oct. 28, 2011.

(51) Int. Cl. H01M 4/62

(52) U.S. Cl. 429/231.8; 29/623.1

(57) ABSTRACT

Additives and methods for improving the performance of an electrochemical cell are described. In particular, the additives and methods may improve the performance of an electrochemical cell having a disordered carbon anode.

### CROSS REFERENCE TO RELATED APPLICATION

This application claims priority from U.S. Provisional Patent Application Ser. No. 61/552,620, filed Oct. 28, 2011, the disclosure of which is hereby expressly incorporated by reference herein in its entirety.

### FIELD OF THE DISCLOSURE

The present disclosure relates to additives and methods for improving the performance of an electrochemical cell and, more particularly, to additives and methods for improving the performance of an electrochemical cell having a disordered carbon anode.

### BACKGROUND OF THE DISCLOSURE

In current practice, flame-retardant additives are used to lower the flammability of a non-aqueous electrolyte when present at sufficient concentrations, such as by preventing or inhibiting combustion of an otherwise combustible electrolyte or by improving the self-extinguishing properties of the electrolyte.

### SUMMARY OF THE DISCLOSURE

According to an embodiment of the present disclosure, a lithium-based electrochemical cell is provided including an anode having a disordered carbon material, the anode having a charge capacity and a discharge capacity, a cathode, an electrolyte in communication with the anode and the cathode, and a flame-retardant additive that improves the performance of the anode by increasing at least one of the charge capacity and the discharge capacity of the anode.

According to another embodiment of the present disclosure, a method is provided for manufacturing a lithium-based electrochemical cell having an anode, a cathode, and an electrolyte. The method includes the steps of providing the anode with an active material, the active material including a disordered carbon material, the anode having a charge capacity and a discharge capacity, and including a flame-retardant additive in the electrochemical cell to improve at least one of the charge capacity and the discharge capacity of the anode.

### BRIEF DESCRIPTION OF THE DRAWINGS

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1 is a schematic view of a lithium-based electrochemical cell having a negative electrode and a positive electrode;

FIG. 2A is a schematic view of a disordered, hard carbon material for use on the negative electrode of FIG. 1;

FIG. 2B is a schematic view of a disordered, soft carbon material for use on the negative electrode of FIG. 1;

FIG. 2C is a schematic view of an ordered carbon material for use on the negative electrode of FIG. 1;

FIG. 3A is an experimental graphical representation of hard carbon half cell formation for different types of flame-retardant additives;

FIG. 3B is an experimental graphical representation of hard carbon half cell formation for different concentrations of flame-retardant additives;

FIG. 3C is an experimental graphical representation of soft carbon half cell formation for different concentrations of flame-retardant additives;

FIG. 3D is an experimental graphical representation of graphite half cell formation for different types of flame-retardant additives;

FIG. 4 is an experimental graphical representation of hard carbon half cell formation for different concentrations of flame-retardant additives and at different discharge rates;

FIG. 5A is an experimental graphical representation of hard carbon full cell formation for different concentrations of flame-retardant additives;

FIG. 5B is an experimental graphical representation of soft carbon full cell formation for different concentrations of flame-retardant additives;

FIG. 5C is an experimental graphical representation of graphite full cell formation for different types of flame-retardant additives;

FIG. 6A is an experimental graphical representation of hard carbon full cell discharging for different concentrations of flame-retardant additives;

FIG. 6B is an experimental graphical representation of soft carbon full cell discharging for different concentrations of flame-retardant additives;

FIG. 6C is an experimental graphical representation of graphite full cell discharging for different types of flame-retardant additives;

FIG. 7A is an experimental graphical representation of hard carbon full cell cycling for different types of flame-retardant additives;

FIG. 7B is an experimental graphical representation of hard carbon full cell cycling for different concentrations of flame-retardant additives;

FIG. 7C is an experimental graphical representation of soft carbon full cell cycling for different concentrations of flame-retardant additives;

FIG. 7D is an experimental graphical representation of graphite full cell cycling for different concentrations of flame-retardant additives;

FIGS. 7E-7G are experimental graphical representations of high-capacity, graphite full cell cycling for different concentrations of flame-retardant additives;

FIG. 8 includes experimental photographs depicting electrolyte absorption into graphite electrodes;

FIGS. 9A and 9B include experimental photographs depicting electrolyte absorption into hard carbon electrodes;

FIGS. 10A and 10B are experimental graphical representations of hard carbon half cell capacity during a forced lithium dendrite test;

FIG. 11 includes experimental photographs depicting forced dendrite formation on the hard carbon electrodes of FIGS. 10A and 10B; and

FIG. 12 is an experimental graphical representation of hard carbon half cell impedance for different types of flame-retardant additives.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION OF THE DRAWINGS

The embodiments disclosed herein are not intended to be exhaustive or to limit the invention to the precise forms disclosed in the following detailed description. Rather, the embodiments are chosen and described so that others skilled in the art may utilize their teachings.

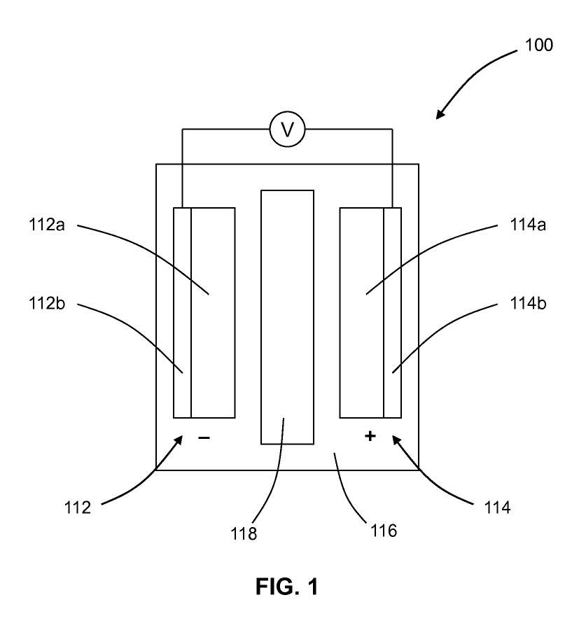

FIG. 1 provides a lithium-based electrochemical cell 100 which may be used in rechargeable and non-rechargeable batteries. Cell 100 may be used in a rechargeable battery of a hybrid vehicle or an electric vehicle, for example, serving as a power source that drives an electric motor of the vehicle. While the present invention primarily involves storing and providing energy for vehicles, it should be understood that the invention may have application to other devices which receive power from batteries, such as a stationary energy storage market. Exemplary applications for a stationary energy storage market include providing power to a power grid, providing power as an uninterrupted power supply, and other loads which may utilize a stationary power source. In one embodiment, the systems and methods disclosed herein may be implemented to provide an uninterrupted power supply for computing devices and other equipment in data centers. A controller of the data center or other load may switch from a main power source to an energy storage system of the present disclosure based on one or more characteristics of the power being received from the main power source or a lack of sufficient power from the main power source.

Cell 100 of FIG. 1 includes a negative electrode (or anode) 112 and a positive electrode (or cathode) 114. Between negative electrode 112 and positive electrode 114, cell 100 of FIG. 1 also contains electrolyte 116 and separator 118. When discharging cell 100, lithium ions travel through electrolyte 116 from negative electrode 112 to positive electrode 114, with electrons flowing in the same direction from negative electrode 112 to positive electrode 114 and current flowing in the opposite direction from positive electrode 114 to negative electrode 112, according to conventional current flow terminology. When charging cell 100, an external power source forces reversal of the current flow from negative electrode 112 to positive electrode 114.

Negative electrode 112 of cell 100 illustratively includes a first layer 112a of an active material that interacts with lithium ions in electrolyte 116 and an underlying substrate or second layer 112b of a conductive material, as shown in FIG. 1. The first, active layer 112a may be applied to one or both sides of the second, conductive layer 112b using a suitable adhesive or binder, such as polyvinylidene fluoride (PVDF) or carboxymethyl cellulose (CMC) plus styrene butadiene rubber (SBR). Exemplary active materials for the first layer 112a of negative electrode 112 include, for example, carbonaceous materials, which are discussed further below. Exemplary conductive materials for the second layer 112b of negative electrode 112 include metals and metal alloys, such as aluminum, copper, nickel, titanium, and stainless steel. The second, conductive layer 112b of negative electrode 112 may be in the form of a thin foil sheet or a mesh, for example.

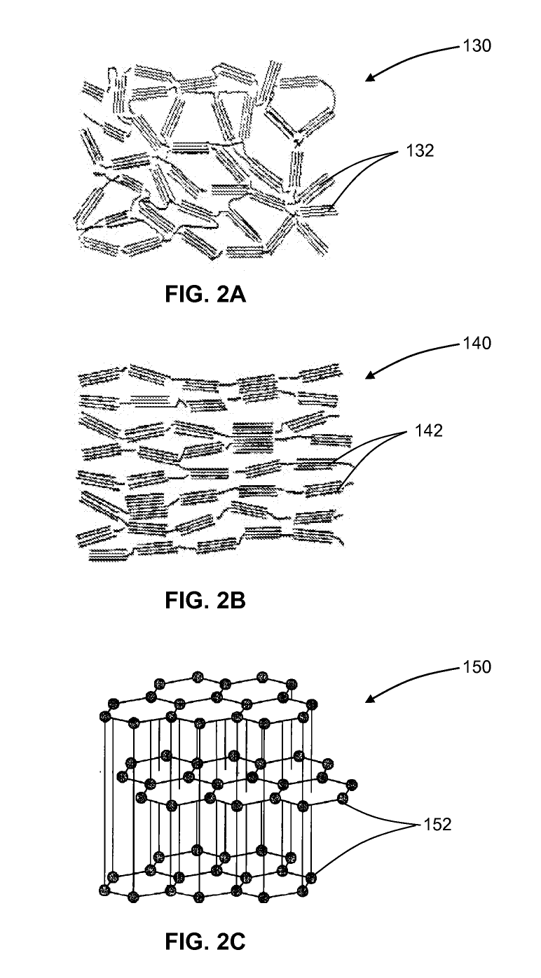

In one exemplary embodiment, the first, active layer 112a of negative electrode 112 (FIG. 1) includes a disordered, non-graphitic, non-crystalline, hard carbon material 130. As shown in FIG. 2A, hard carbon 130 includes a plurality of disordered, unevenly spaced graphene sheets 132 of varied shapes and sizes, with adjacent graphene sheets 132 being spaced apart by about 0.38 nm or more to receive lithium ions there between. The disordered, uneven spacing of graphene sheets 132 is shown in FIG. 2A, for example, with some graphene sheets 132 being oriented generally horizontally and other graphene sheets 132 being oriented generally vertically. Hard carbon materials 130 are generally made from organic precursors that char as they pyrolyze.

In another exemplary embodiment, the first, active layer 112a of negative electrode 112 (FIG. 1) includes a disordered, non-graphitic, non-crystalline, soft carbon material 140. As shown in FIG. 2B, soft carbon 140 includes a plurality of stacked, unevenly spaced graphene sheets 142 of varied shapes and sizes, with adjacent graphene sheets 142 being spaced apart by about 0.375 nm or more to receive lithium ions there between. Compared to graphene sheets 132 of hard carbon 130 (FIG. 2A), graphene sheets 142 of soft carbon 140 (FIG. 2B) are more closely aligned for more even stacking. Soft carbon materials 140 are generally made from organic precursors that melt before they pyrolyze.

It is also within the scope of the present disclosure that the first, active layer 112a of negative electrode 112 (FIG. 1) may include an ordered, crystalline carbon material, such as graphite 150. As shown in FIG. 2C, graphite 150 includes a plurality of neatly stacked graphene sheets 152, with adjacent graphene sheets being arranged in parallel and being substantially evenly spaced apart by about 0.335 nm to receive lithium ions there between. Due to the tight spacing between adjacent graphene sheets 152, graphite 150 may expand in volume by about 10% to accommodate lithium ions between the adjacent graphene sheets 152.

Ordered carbon electrodes, such as electrodes made of graphite 150 (FIG. 2C), have a theoretical maximum capacity of 372 mAh/g. In theory, disordered carbon electrodes, such as electrodes made of hard carbon 130 (FIG. 2A) or soft carbon 140 (FIG. 2B), may be capable of having higher capacities than ordered carbon electrodes. For example, while adjacent graphene sheets 152 of graphite 150 (FIG. 2C) may be required to fluctuate in spacing to accommodate lithium ions, adjacent graphene sheets 132 of hard carbon 130 (FIG. 2A) and adjacent graphene sheets 142 of soft carbon 140 (FIG. 2B) may be sufficiently spaced apart (e.g., spaced apart by more than about 0.34 nm, 0.35 nm, 0.36 nm, 0.37 nm, 0.38 nm, 0.39 nm, or 0.40 nm) to accommodate lithium ions without fluctuating in spacing. However, in practice, disordered carbon electrodes tend to suffer from lower capacities than ordered carbon electrodes.

Returning to FIG. 1, positive electrode 114 of cell 100 illustratively includes a first layer 114a of an active material that interacts with lithium ions in electrolyte 116 and an underlying substrate or second layer 114b of a conductive material. Like the first, active layer 112a of negative electrode 112, the first, active layer 114a of positive electrode 114 may be applied to one or both sides of the second, conductive layer 114b using a suitable adhesive or binder, such as PVDF or CMC plus SBR. Exemplary active materials for the first layer 114a of positive electrode 114 include metal oxides, such as LiMn₂O₄ (LMO), LiCoO₂ (LCO), LiNiO₂, LiFePO₄, LiNiCoMnO₂, and combinations thereof. Exemplary conductive materials for the second layer 114b of positive electrode 114 include metals and metal alloys, such as aluminum, titanium, and stainless steel. The second, conductive layer 114b of positive electrode 114 may be in the form of a thin foil sheet or a mesh, for example.

As shown in FIG. 1, negative electrode 112 and positive electrode 114 of cell 100 are plate-shaped structures. It is also within the scope of the present disclosure that negative electrode 112 and positive electrode 114 of cell 100 may be provided in other shapes or configurations, such as coiled configurations. It is further within the scope of the present disclosure that multiple negative electrodes 112 and positive electrodes 114 may be arranged together in a stacked configuration.

Electrolyte 116 of cell 100 illustratively includes a lithium salt dissolved in an organic, non-aqueous solvent. The solvent of electrolyte 116 may be in a liquid state, in a solid state, or in a gel form between the liquid and solid states. Suitable liquid solvents for use as electrolyte 116 include, for example, cyclic carbonates (e.g. propylene carbonate (PC), ethylene carbonate (EC)), alkyl carbonates, dialkyl carbonates (e.g., dimethyl carbonate (DMC), diethyl carbonate (DEC), ethyl methyl carbonate (EMC)), cyclic ethers, cyclic esters, glymes, lactones, formates, esters, sulfones, nitrates, oxazoladinones, and combinations thereof. Suitable solid solvents for use as electrolyte 116 include, for example, polyethylene oxide (PEO), polyacrylonitrile (PAN), polymethylene-polyethylene oxide (MPEO), polyvinylidene fluoride (PVDF), polyphosphazenes (PPE), and combinations thereof. Suitable lithium salts for use in electrolyte 116 include, for example, LiPF₆, LiClO₄, LiSCN, LiAlCl₄, LiBF₄, LiN(CF₃SO₂)₂, LiCF₃SO₃, LiC(SO₂CF₃)₃, LiO₃SCF₂CF₃, LiC₆F₅SO₃, LiCF₃CO₂, LiAsF₆, LiSbF₆, and combinations thereof. Electrolyte 116 may comprise various combinations of the materials exemplified herein.

Separator 118 of cell 100 is illustratively positioned between negative electrode 112 and positive electrode 114 to prevent a short circuit within cell 100. Separator 118 may be in the form of a polyolefin membrane (e.g., a polyethylene membrane, a polypropylene membrane) or a ceramic membrane, for example.

One or more flame-retardant additives may be included in cell 100. When present at a sufficient concentration in electrolyte 116, the flame-retardant additive may be capable of producing a flame-retardant effect in electrolyte 116, such as by preventing or inhibiting combustion of electrolyte 116, improving the self-extinguishing properties of electrolyte 116, and/or scavenging highly reactive substances produced when electrolyte 116 begins to decompose. Additionally, the flame-retardant additive may be capable of improving the performance of cell 100, and in particular the performance of negative electrode 112 of cell 100. Specifically, the flame-retardant additive may be capable of increasing the charge capacity of negative electrode 112 (i.e., the capacity reached by negative electrode 112 during charging of the full cell 100) and/or the discharge capacity of negative electrode 112 (i.e., the capacity retained by negative electrode 112 during discharging of the full cell 100).

An exemplary flame-retardant additive for electrolyte 116 is capable of improving the performance of negative electrode 112 of cell 100 even at concentrations below those which are necessary to produce a flame-retardant effect in electrolyte 116. For example, if a flame-retardant additive concentration of at least about 5 wt. % or 6 wt. % in electrolyte 116 is necessary to produce a flame-retardant effect, a flame-retardant additive concentration less than about 5 wt. % or 6 wt. % may be capable of improving the performance of negative electrode 112 of cell 100. In this example, the performance-enhancing concentration of the flame-retardant additive may be between about 0.1 wt. % and 4 wt. %, or between about 0.5 wt. % and 3 wt. %, or between about 1 wt. % % and 2 wt. %.

Also, an exemplary flame-retardant additive for electrolyte 116 includes a phosphorus-containing moiety. Such phosphorus-containing flame-retardant additives react when heated to produce phosphoric acid, which may prevent or inhibit pyrolysis of negative electrode 112, positive electrode 114, and electrolyte 116, and thereby prevent or inhibit the production of fuel for flames.

In one embodiment, the flame-retardant additive includes a phosphazene-containing moiety. The flame-retardant effect of a cyclic phosphazene is described in U.S. Patent Application Publication No. 2010/0062345 to Horikawa, the disclosure of which is expressly incorporated herein by reference. The flame-retardant effect of another phosphazene compound is described in U.S. Pat. No. 7,067,219 to Otsuki et al., the disclosure of which is expressly incorporated herein by reference. Suitable phosphazene-based flame-retardant additives are commercially available as Phoslyte™ E and Phoslyte™ P additives from Nippon Chemical Industrial Co., Ltd. of White Plains, N.Y. Phoslyte™ is a registered trademark of Bridgestone Corporation of Tokyo, Japan. Another suitable phosphazene-based flame-retardant additive is commercially available as a J2 additive from Novolyte Technologies of Independence, Ohio.

In other embodiments, the flame-retardant additive includes another phosphorus-containing moiety, such as a phosphate (e.g., trimethyl phosphate), a phosphite (e.g., tris(2,2,2-trifluoroethyl)phosphite (TTFP)), a phosphonate, and/or a phosphinate, for example.

An exemplary flame-retardant additive may be capable of increasing the discharge capacity of negative electrode 112, as discussed above. The discharge capacity of negative electrode 112 may be measured during formation in a half cell and may be expressed as an initial specific capacity and/or a reversible specific capacity. When the first, active layer 112a of negative electrode 112 is a disordered carbon material, such as hard carbon 130 (FIG. 2A) or soft carbon 140 (FIG. 2B), the half cell initial specific capacity and reversible specific capacity of negative electrode 112 may increase by at least about 3% with a flame-retardant additive, and in certain cases by about 5%, 10%, 15%, 20%, 25%, or more with a flame-retardant additive.

The magnitude of the initial specific capacity increase may be more significant when the first, active layer 112a of negative electrode 112 is a disordered carbon material, such as hard carbon 130 (FIG. 2A) or soft carbon 140 (FIG. 2B), than when the first, active layer 112a is an ordered carbon material, such as graphite 150 (FIG. 2C). For example, in the presence of an electrolyte having a flame-retardant additive concentration of about 5 wt. % to 6 wt. %, the half cell initial specific capacity of negative electrode 112 may increase by about 40 mAh/g or more (e.g., 40 mAh/g, 45 mAh/g, 50 mAh/g, 55 mAh/g, 60 mAh/g, 65 mAh/g, 70 mAh/g, 75 mAh/g, 80 mAh/g, or more) when the active material is hard carbon 130 (FIG. 2A), by about 10 mAh/g or more (e.g., 10 mAh/g, 15 mAh/g, 20 mAh/g, 25 mAh/g, or more) when the active material is soft carbon 140 (FIG. 2B), and by less than about 10 mAh/g (e.g., 1 mAh/g or 5 mAh/g) when the active material is graphite 150 (FIG. 2C).

Like the initial specific capacity increase discussed above, the magnitude of the reversible specific capacity increase may also be more significant when the first, active layer 112a of negative electrode 112 is a disordered carbon material, such as hard carbon 130 (FIG. 2A) or soft carbon 140 (FIG. 2B), than when the first, active layer 112a is an ordered carbon material, such as graphite 150 (FIG. 2C). For example, in the presence of an electrolyte having a flame-retardant additive concentration of about 5 wt. % to 6 wt. %, the half cell reversible specific capacity of negative electrode 112 may increase by about 30 mAh/g or more (e.g., 30 mAh/g, 35 mAh/g, 40 mAh/g, 45 mAh/g, 50 mAh/g, 55 mAh/g, 60 mAh/g, 65 mAh/g, 70 mAh/g, 75 mAh/g, 80 mAh/g, or more) when the active material is hard carbon 130 (FIG. 2A), by about 5 mAh/g or more (e.g., 5, mAh/g, 10 mAh/g, 15 mAh/g, 20 mAh/g, or more) when the active material is soft carbon 140 (FIG. 2B), and by less than about 5 mAh/g (e.g., 1 mAh/g or 3 mAh/g) when the active material is graphite 150 (FIG. 2C).

The impact of flame-retardant additives on discharge capacity during formation in a half cell is discussed further in Examples 1-A, 1-B, and 1-C below.

The above-described discharge capacity improvement may occur at different discharge rates. For example, in the presence of an electrolyte having a flame-retardant additive concentration of about 6 wt. %, the half cell discharge capacity may increase by about 5 mAh/g or more (e.g., 10 mAh/g, 20 mAh/g, 30 mAh/g, 40 mAh/g, 50 mAh/g, or more) at a specified discharge rate. The flame-retardant additive may also make the discharge capacity more consistent between similar half cells. The impact of flame-retardant additives on discharge capacity at various charge rates is discussed further in Example 2 below.

In certain embodiments, the increased discharge capacity of negative electrode 112 may be evident in full cell 100. However, if the capacity of full cell 100 is limited by positive electrode 114, the full cell 100 results may be less significant than the above-described half cell results. The impact of flame-retardant additives on the discharge capacity of the full cell 100 during formation is discussed further in Example 3 below.

The impact of flame-retardant additives on the discharge rate capability of the full cell 100 at various discharge rates is discussed further in Example 4 below.

The above-described discharge capacity improvement may occur during initial cycling (e.g., 0-1 cycle) and early cycling (e.g., 1-50 cycles, 1-100 cycles, 1-150 cycles, or 1-200 cycles) of the full cell 100. When the first, active layer 112a of negative electrode 112 is a disordered carbon material, such as hard carbon 130 (FIG. 2A) or soft carbon 140 (FIG. 2B), the flame-retardant additive may also be capable of improving the discharge capacity of the full cell 100 during subsequent cycling (e.g., 50+ cycles, 100+ cycles, 150+ cycles, or 200+ cycles). By contrast, when the first, active layer 112a of negative electrode 112 is an ordered carbon material, such as graphite 150 (FIG. 2C), the flame-retardant additive may actually hinder the discharge capacity of the full cell 100 during subsequent cycling. The impact of flame-retardant additives on cycle performance is discussed further in Examples 5-A, 5-B, and 5-C below.

In addition to improving the discharge capacity of negative electrode 112, an exemplary flame-retardant additive may also be capable of increasing the charge capacity of negative electrode 112, as discussed above. The charge capacity of negative electrode 112 may be measured in a half cell or in the full cell 100 and may occur at different charge rates.

The charge capacity improvements discussed above may be especially significant when the first, active layer 112a of negative electrode 112 is a disordered carbon material, such as hard carbon 130 (FIG. 2A) or soft carbon 140 (FIG. 2B), that was coated onto the second, conductive layer 112b of negative electrode 112 and then aged about 1 month, 3 months, 6 months, 12 months, or longer.

Without wishing to be bound by theory, the present inventors believe that a flame-retardant additive in electrolyte 116 may act as a wetting agent to improve the capacity of negative electrode 112. In operation, lithium ions in electrolyte 116 may more easily and evenly access small, wetted pores in the first, active layer 112a of negative electrode 112, especially during initial and early cycling. The impact of flame-retardant additives on surface wettability is discussed further in Examples 6-A, 6-B, and 6-C below.

Additionally, a flame-retardant additive in electrolyte 116 may develop and/or enhance a desirable solid electrolyte interphase (SEI) layer on negative electrode 112 to lower impedance and improve cycleability. The impact of flame-retardant additives on impedance is discussed further in Example 7 below.

Furthermore, a flame-retardant additive in electrolyte 116 may scavenge and displace oxygen, water, or other reactive products on the surface of negative electrode 112 to improve the capacity of negative electrode 112. As a result, even if negative electrode 112 has been aged or exposed to the atmosphere, the flame-retardant additive may effectively regenerate negative electrode 112. This regeneration effect may be more significant when the first, active layer 112a of negative electrode 112 is a disordered carbon material, such as hard carbon 130 (FIG. 2A) or soft carbon 140 (FIG. 2B), than when the first, active layer 112a of negative electrode 112 is an ordered carbon material, such as graphite 150 (FIG. 2C), because disordered carbon materials tend to deteriorate over time while ordered carbon materials tend to remain stable over time. In current practice, negative electrode 112 that is coated with a disordered carbon material and then shelved may need to be discarded after about 3 months. By using a flame-retardant additive, as described herein, such an aged negative electrode 112 may be rejuvenated rather than being discarded, even after being shelved for about 3 months, 6 months, 12 months, or longer.

### EXAMPLES

The following examples illustrate the impact of flame-retardant additives on lithium ion half cells and full cells. Various baseline electrolytes were used to form the tested cells, including LiPF₆ salt based with cyclic carbonates EC and PC as well as linear carbonate EMC. Unless otherwise indicated, the tested cells were bag-type cells and were charged and discharged at ambient temperature.

### 1-A. Example 1-A

### Impact of Flame-Retardant Additive Type on Discharge Capacity of Hard Carbon Electrodes

To evaluate the impact of different types of flame-retardant additives on the discharge capacity of hard carbon electrodes during formation, four (4) half cells were assembled with lithium metal as the active material on each anode and hard carbon as the active material on each cathode. The baseline electrolytes of three (3) of the half cells were modified to include a flame-retardant additive in a desired concentration, while the baseline electrolyte of the remaining half cell was left without a flame-retardant additive to serve as the control, as set forth in Table 1-A below.

TABLE 1-A

| | Flame-Retardant Additive | | Reversible | Initial |
|---|---|---|---|---|
| Active | | Concentration | Specific Capacity | Specific Capacity |
| Material | Type | (wt. %) | (mAh/g) | (mAh/g) |
| Hard carbon | — | 0.0 | 270 | 348 |
| Hard carbon | Phoslyte ™ E (PE) | 5.0 | 344 | 429 |
| Hard carbon | Phoslyte ™ P (PP) | 5.0 | 330 | 418 |
| Hard carbon | J2 | 6.0 | 333 | 419 |

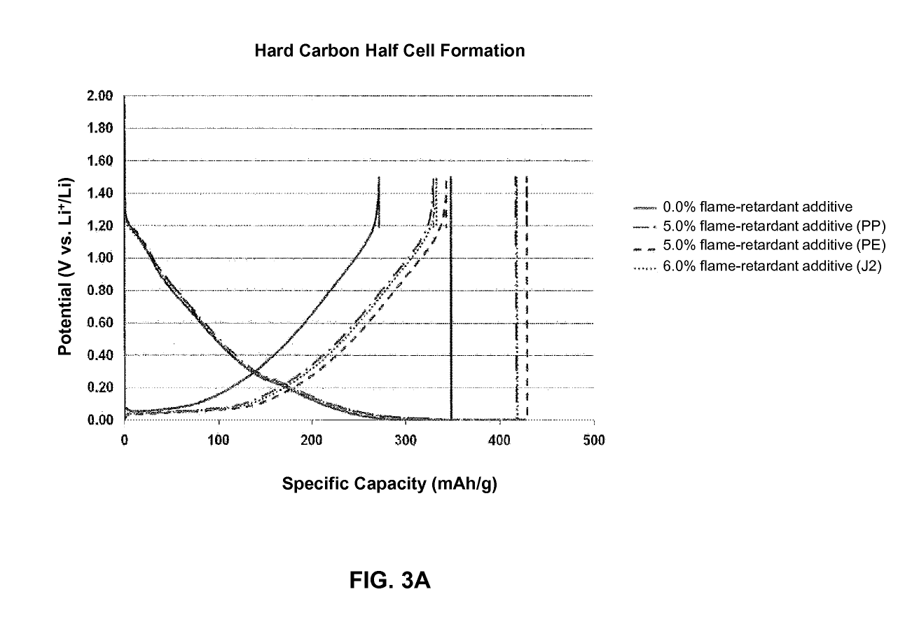

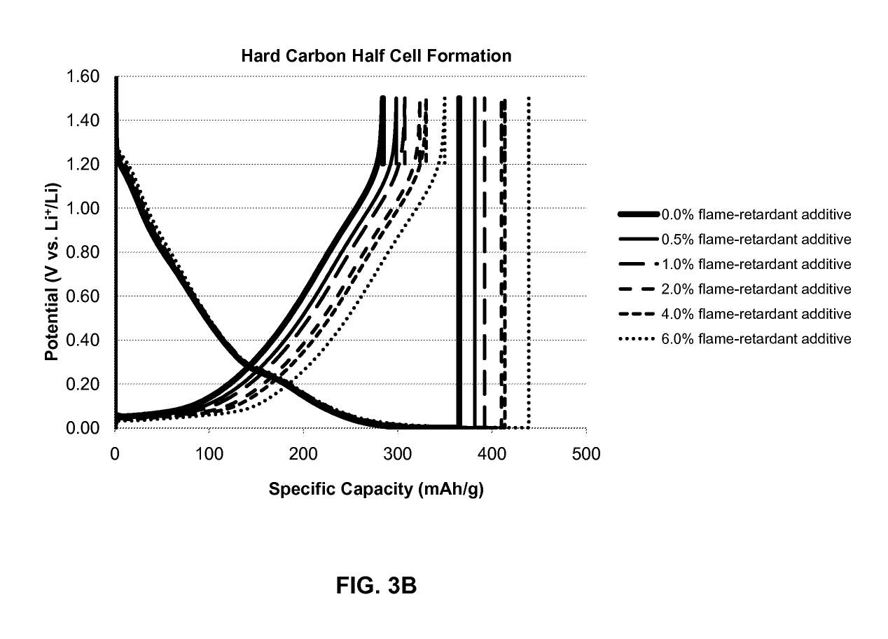

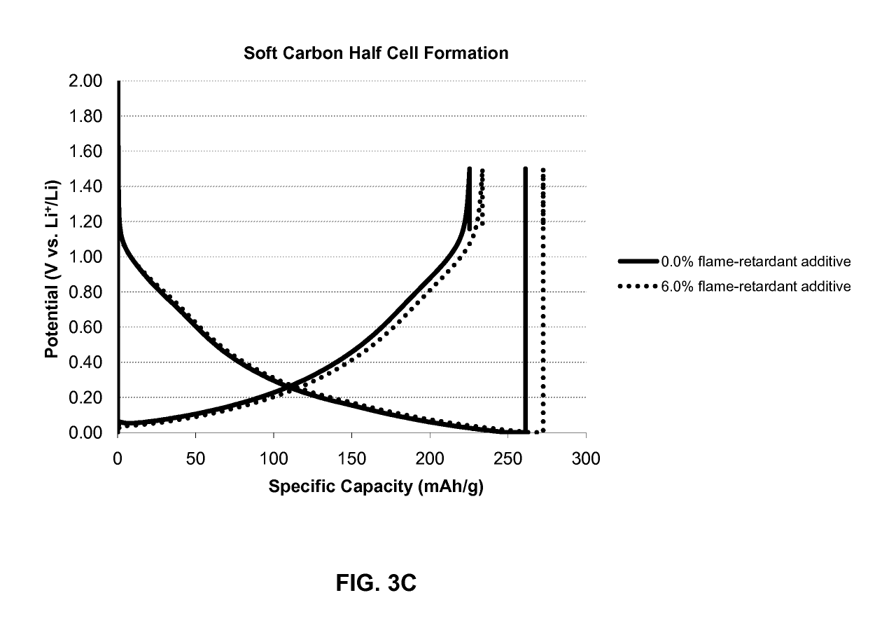

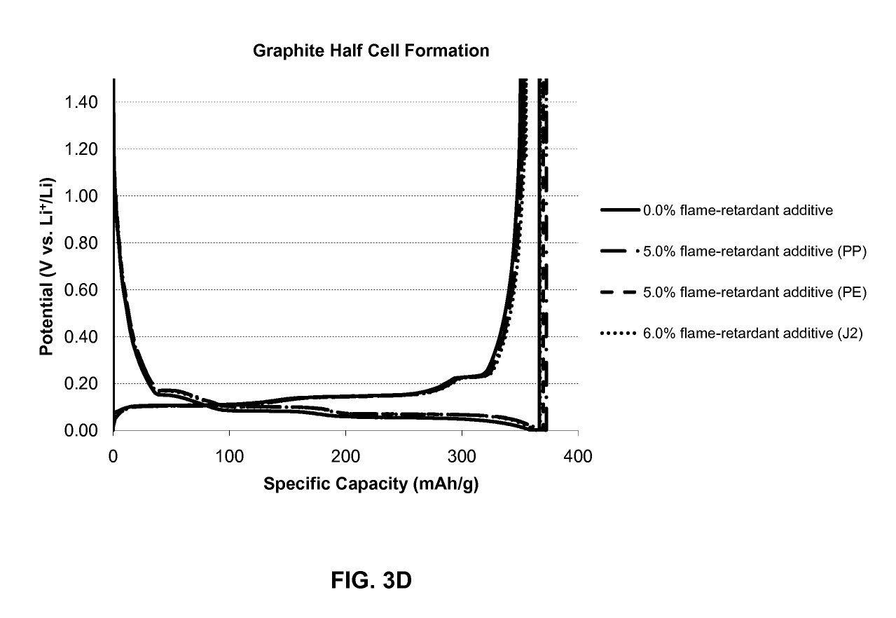

Each half cell was charged at C/20 to 0.002V and then discharged at C/10 to 1.5 V. The results are presented in Table 1-A above and in FIG. 3A.

The flame-retardant additives improved the discharge capacities of the corresponding hard carbon electrodes during formation. With Phoslyte™ E as the flame-retardant additive, for example, the reversible specific capacity of the hard carbon electrode increased by 74 mAh/g (from 270 mAh/g to 344 mAh/g), representing more than a 27% increase, and the initial specific capacity of the hard carbon electrode increased by 81 mAh/g (from 348 mAh/g to 429 mAh/g), representing more than a 23% increase.

### 1-B. Example 1-B

### Impact of Flame-Retardant Additive Concentration on Discharge Capacity of Hard Carbon Electrodes

To evaluate the impact of different concentrations of flame-retardant additives on the discharge capacity of hard carbon electrodes during formation, six (6) half cells were assembled with lithium metal as the active material on each anode and hard carbon as the active material on each cathode. The baseline electrolytes of five (5) of the half cells were modified to include a flame-retardant additive in a desired concentration, while the baseline electrolyte of the remaining half cell was left without a flame-retardant additive to serve as the control, as set forth in Table 1-B below.

TABLE 1-B

| | | | Reversible | Initial |
|---|---|---|---|---|
| | Flame-Retardant Additive | | Specific | Specific |
| Active | | Concentration | Capacity | Capacity |
| Material | Type | (wt. %) | (mAh/g) | (mAh/g) |
| Hard carbon | — | 0.0 | 287 | 369 |
| Hard carbon | J2 | 0.5 | 297 | 381 |
| Hard carbon | J2 | 1.0 | 309 | 394 |
| Hard carbon | J2 | 2.0 | 321 | 407 |
| Hard carbon | J2 | 4.0 | 330 | 415 |
| Hard carbon | J2 | 6.0 | 349 | 438 |

Each half cell was charged at C/20 to 0.002V and then discharged at C/10 to 1.5 V. The results are presented in Table 1-B above and in FIG. 3B.

The discharge capacities of the hard carbon electrodes increased as the concentration of the flame-retardant additive increased. For example, in the presence of an electrolyte having just 0.5 wt. % of the flame-retardant additive, the reversible specific capacity increased by 10 mAh/g (from 287 mAh/g to 297 mAh/g), representing a 3.5% increase, and the initial specific capacity increased by 12 mAh/g (from 369 mAh/g to 381 mAh/g), representing a 3.3% increase. In the presence of an electrolyte having 6.0 wt. % of the flame-retardant additive, the reversible specific capacity increased by 62 mAh/g (from 287 mAh/g to 349 mAh/g), representing a 21.6% increase, and the initial specific capacity increased by 69 mAh/g (from 369 mAh/g to 438 mAh/g), representing a 18.7% increase.

### 1-C. Example 1-C

### Impact of Flame-Retardant Additives on Discharge Capacity of Hard Carbon, Soft Carbon, and Graphite Electrodes

To evaluate the impact of flame-retardant additives on the discharge capacity of different electrodes during formation, three (3) sets of corresponding half cells were assembled with lithium metal as the active material on each anode. For the active material on the cathode, the first set of half cells used hard carbon, the second set of half cells used soft carbon, and the third set of half cells used graphite. Flame-retardant additives were added to the baseline electrolytes of certain half cells and in various concentrations, while the baseline electrolytes of other half cells were left without a flame-retardant additive to serve as the controls, as set forth in Table 1-C below.

TABLE 1-C

| | Flame-Retardant Additive | | Reversible | Initial |
|---|---|---|---|---|
| Active | | Concentration | Specific Capacity | Specific Capacity |
| Material | Type | (wt.%) | (mAh/g) | (mAh/g) |
| Hard carbon | — | 0.0 | 287 | 369 |
| Hard carbon | J2 | 0.5 | 297 | 381 |
| Hard carbon | J2 | 1.0 | 309 | 394 |
| Hard carbon | J2 | 2.0 | 321 | 407 |
| Hard carbon | J2 | 4.0 | 330 | 415 |
| Hard carbon | J2 | 6.0 | 349 | 438 |
| Soft carbon | — | 0.0 | 225 | 260 |
| Soft carbon | J2 | 6.0 | 234 | 273 |
| Graphite | — | 0.0 | 350 | 366 |
| Graphite | Phoslyte ™ E (PE) | 5.0 | 355 | 372 |
| Graphite | Phoslyte ™ P (PP) | 5.0 | 352 | 367 |
| Graphite | J2 | 6.0 | 354 | 370 |

Each half cell of each type was formed by charging to 0.002V at a C/10 rate, then discharged at C/10 to 1.5V. The results are presented in Table 1-C above and in FIGS. 3B-3D.

The flame-retardant additives improved the initial specific capacities of the hard carbon and soft carbon electrodes more than the corresponding graphite electrodes. The initial specific capacity of the hard carbon electrodes increased by as much as 69 mAh/g (from 369 mAh/g to 438 mAh/g), representing a 18.7% increase. The initial specific capacity of the soft carbon electrodes increased by as much as 13 mAh/g (from 260 mAh/g to 273 mAh/g), representing a 5% increase. However, the initial specific capacity of the graphite electrodes increased by at most 6 mAh/g (from 366 mAh/g to 372 mAh/g), representing about a 2% increase. In one particular graphite half cell, the initial specific capacity of the graphite electrode increased by only 1 mAh/g (from 366 mAh/g to 367 mAh/g), representing less than a 0.3% increase.

The flame-retardant additives also improved the reversible specific capacities of the hard carbon and soft carbon electrodes more than the graphite electrodes. The reversible specific capacity of the hard carbon electrodes increased by as much as 62 mAh/g (from 287 mAh/g to 349 mAh/g), representing a 21.6% increase. The reversible specific capacity of the soft carbon electrodes increased by as much as 9 mAh/g (from 225 mAh/g to 234 mAh/g), representing a 4% increase. However, the reversible specific capacity of the graphite electrodes increased by 5 mAh/g at most (from 350 mAh/g to 355 mAh/g), representing less than a 2% increase. In one particular graphite half cell, the reversible specific capacity of the graphite electrode increased by only 2 mAh/g (from 350 mAh/g to 352 mAh/g), representing about a 0.5% increase.

As shown by comparing FIGS. 3B and 3D, a flame-retardant additive is capable of improving the initial and reversible specific capacities of a hard carbon electrode to approach and/or exceed the initial and reversible specific capacities of a graphite electrode. The initial specific capacity of the hard carbon electrode reached as high as 438 mAh/g in the presence of a flame-retardant additive, which exceeds the 372 mAh/g reached by the graphite electrode in the presence of a flame-retardant additive. Also, the reversible specific capacity of the hard carbon electrode reached as high as 349 mAh/g in the presence of a flame-retardant additive, which approaches the 355 mAh/g reached by the graphite electrode in the presence of a flame-retardant additive.

### 2. Example 2

### Impact of Flame-Retardant Additive Concentration on Discharge Capacity of Hard Carbon Electrodes at Different Discharge Rates

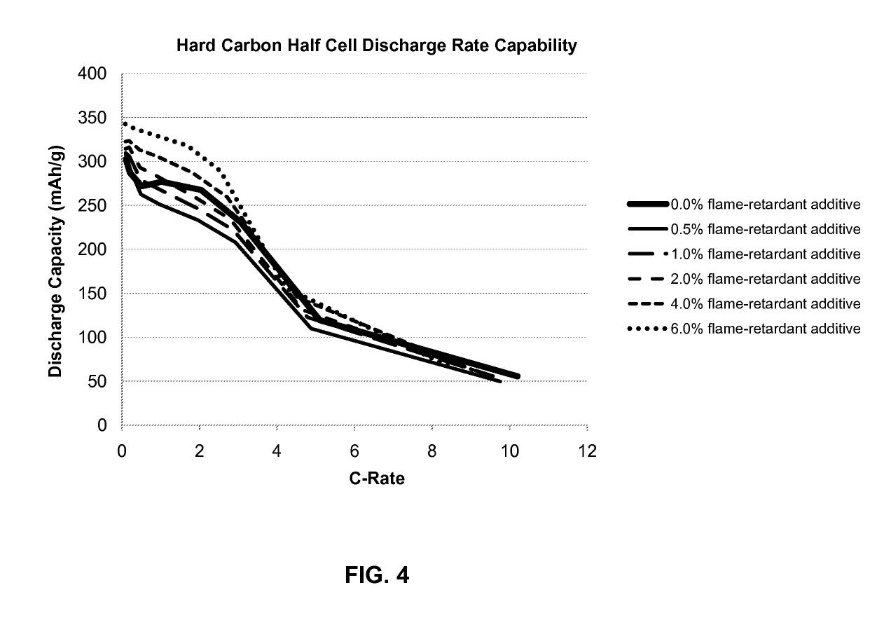

To evaluate the impact of different concentrations of flame-retardant additives on the discharge capacity of hard carbon electrodes at different discharge rates, multiple hard carbon half cells were assembled according to Table 1-B above. Each half cell was charged to 0.002 V, then discharged at a specified discharge rate to 1.5 V. The results are presented in FIG. 4.

As shown in FIG. 4, the discharge capacity of the hard carbon electrodes increased as the concentration of the flame-retardant additive increased, at least at discharge rates (C-Rates) of 6 or less. For example, at a C-Rate of 2, the discharge capacity averaged less than 250 mAh/g in the presence of an electrolyte having 0.5 wt. % of the flame-retardant additive and averaged more than 300 mAh/g in the presence of an electrolyte having 6.0 wt. % of the flame-retardant additive.

Although the data for like half cells is averaged together in FIG. 4, the flame-retardant additives also improved the consistency of this data between like half cells. For example, at a C-Rate of 2, the discharge capacity varied by less than 25 mAh/g between the hard carbon half cells having 4.0 wt. % of the flame-retardant additive, but the discharge capacity varied by about 50 mAh/g between the hard carbon half cells that lacked a flame-retardant additive.

### 3. Example 3

### Impact of Flame-Retardant Additives on Discharge Capacity of Hard Carbon, Soft Carbon, and Graphite Full Cells

To evaluate the impact of flame-retardant additives on the discharge capacity of different full cells during formation, three (3) sets of full cells were assembled with mixed oxide as the active material on each cathode. For the active material on the anode, the first set of cells used hard carbon, the second set of cells used soft carbon, and the third set of cells used graphite. Flame-retardant additives were added to the baseline electrolytes of certain cells and in various concentrations, while the baseline electrolytes of other cells were left without a flame-retardant additive to serve as the controls, as set forth in Table 3 below.

TABLE 3

| | Flame-Retardant Additive | |
|---|---|---|
| Active | | Concentration |
| Material | Type | (wt. %) |
| Hard carbon | — | 0.0 |
| Hard carbon | J2 | 6.0 |
| Soft carbon | — | 0.0 |
| Soft carbon | J2 | 6.0 |
| Graphite | — | 0.0 |
| Graphite | J2 | 6.0 |

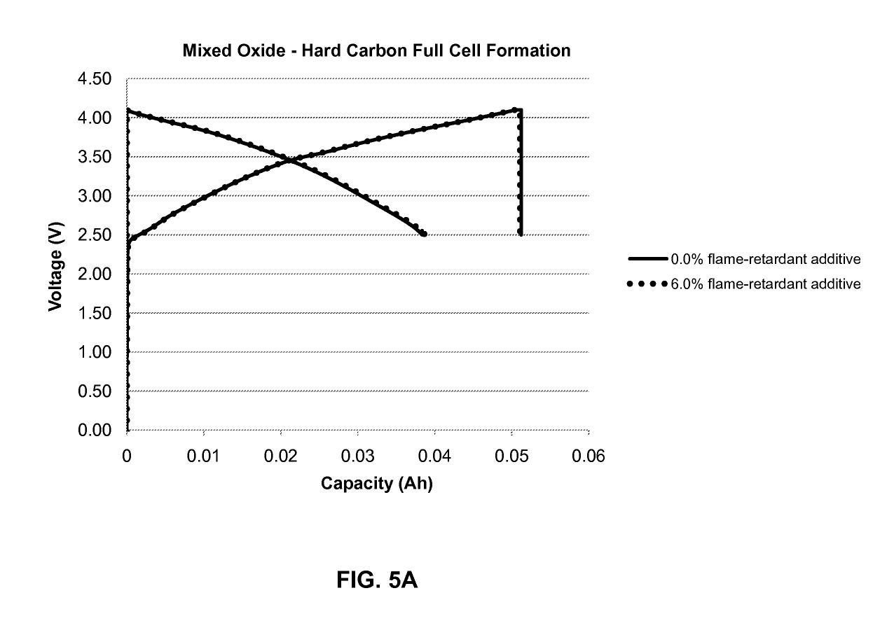

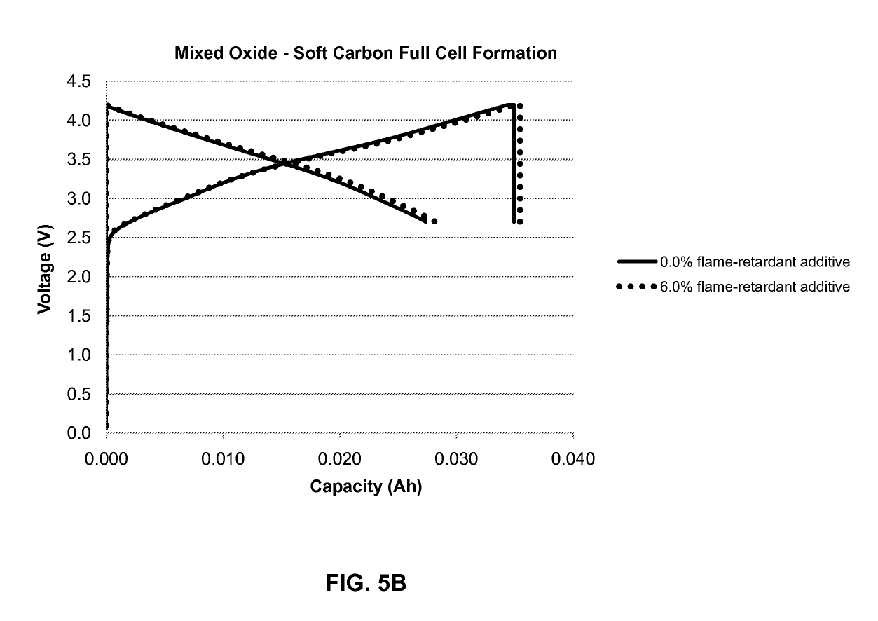

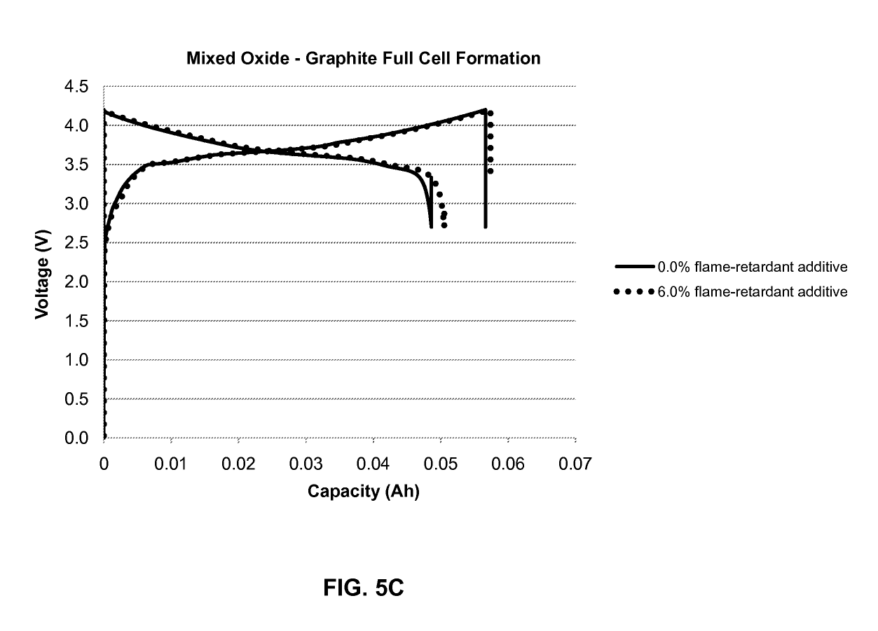

The hard carbon full cells were charged at C/10 to 4.1 V, then at a constant voltage of 4.1 V for 1 hour, and were discharged at C/10 to 2.5 V. The soft carbon full cells were charged at C/10 to 4.2 V, then at a constant voltage of 4.2 V for 1 hour, and were discharged at C/10 to 2.7 V. The graphite full cells were charged at C/10 to 4.2 V, then at a constant voltage of 4.2 V for 1 hour, and were discharged at C/10 to 2.7 V. The results are presented in FIGS. 5A-5C.

As shown in FIGS. 5A-5C, the flame-retardant additives had a slight impact on the discharge capacity of each full cell. In Example 1-C above (FIGS. 3A-3D), the flame-retardant additives were shown to have a substantial impact on the discharge capacity of the anodes in the half cells. However, because the charge capacity of each full cell is cathode-limited, the full cell results of FIGS. 5A-5C are less significant than the half cell results of FIGS. 3A-3D.

### 4. Example 4

### Impact of Flame-Retardant Additives on Discharge Rate Capability of Hard Carbon, Soft Carbon, and Graphite Full Cells

To evaluate the impact of flame-retardant additives on the discharge rate capability of different full cells, three (3) sets of full cells were assembled according to Table 3 above, the first set using hard carbon, the second set using soft carbon, and the third set using graphite as the active material on the anode.

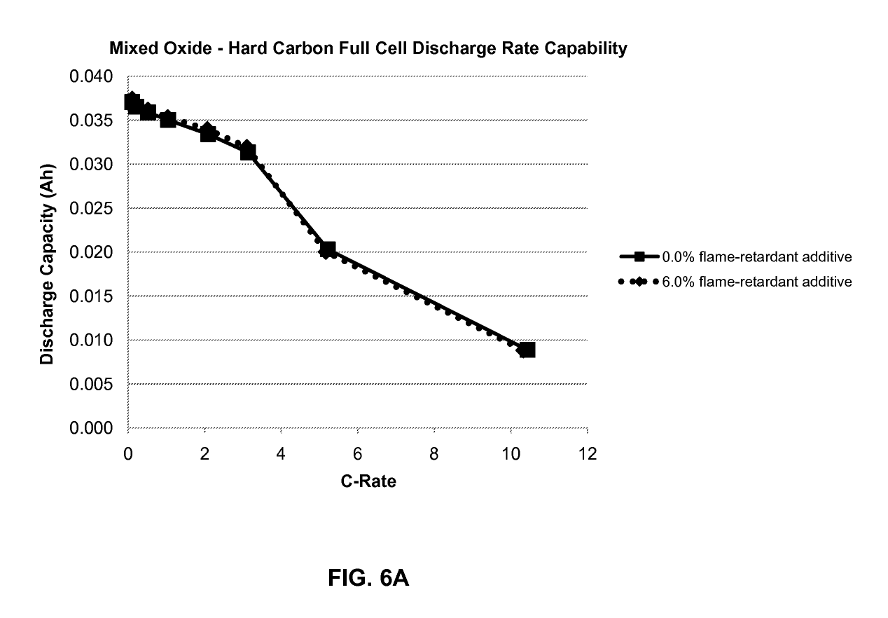

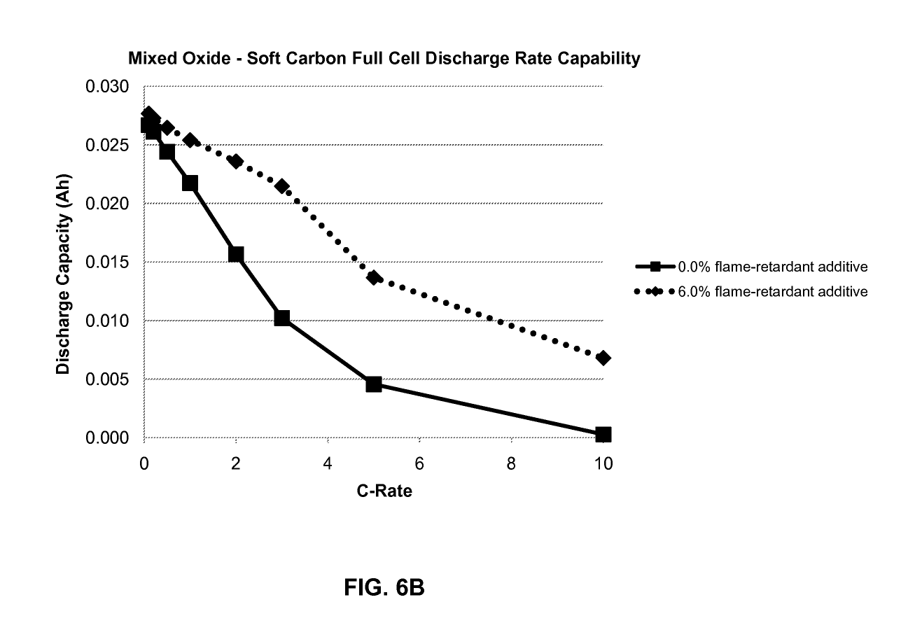

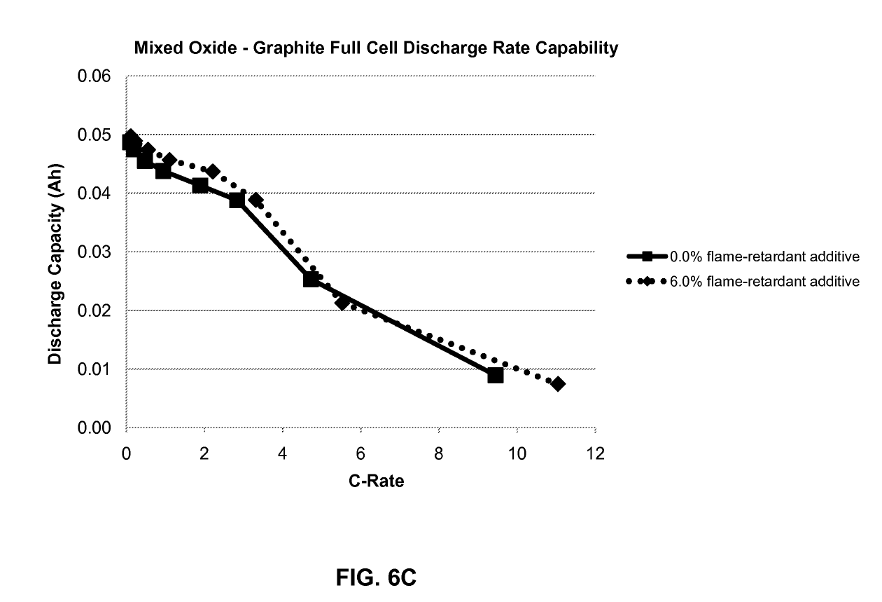

The hard carbon full cells were charged at C/2 to 4.1 V, then at a constant voltage of 4.1 V for 1 hour, and were discharged at a specified discharge rate to 2.5 V. The soft carbon full cells were charged at C/2 to 4.2 V, then at a constant voltage of 4.2 V for 1 hour, and were discharged at a specified discharge rate to 2.7 V. The graphite full cells were charged at C/2 to 4.2 V, then at a constant voltage until current dropped below C/20, and were discharged at a specified discharge rate to 2.7 V. The results are presented in FIGS. 6A-6C.

With reference to FIG. 6B, in particular, the flame-retardant additives had the most significant impact on the discharge capacity of the soft carbon cells. The soft carbon electrodes had been coated over 12 months before being tested in the present Example 4 and had likely been exposed to air. Without wishing to be bound by theory, the present inventors believe that the flame-retardant additives may have effectively regenerated the aged, soft carbon electrodes by scavenging and displacing oxygen, water, and/or other reactive products on the surface of the electrodes.

### 5-A. Example 5-A

### Impact of Flame-Retardant Additive Type on Cycle Performance of Hard Carbon Full Cells

To evaluate the impact of different types of flame-retardant additives on the cycle performance of hard carbon cells, four (4) full cells were assembled with mixed oxide as the active material on each cathode and hard carbon as the active material on each anode. The baseline electrolytes of three (3) of the half cells were modified to include a flame-retardant additive in a desired concentration, while the baseline electrolyte of the remaining half cell was left without a flame-retardant additive to serve as the control, as set forth in Table 1-A above.

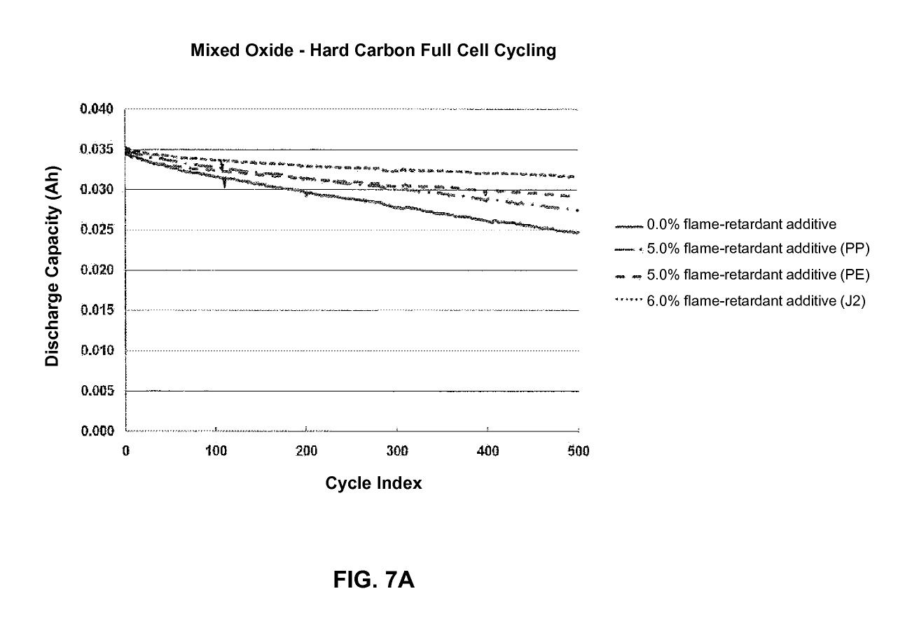

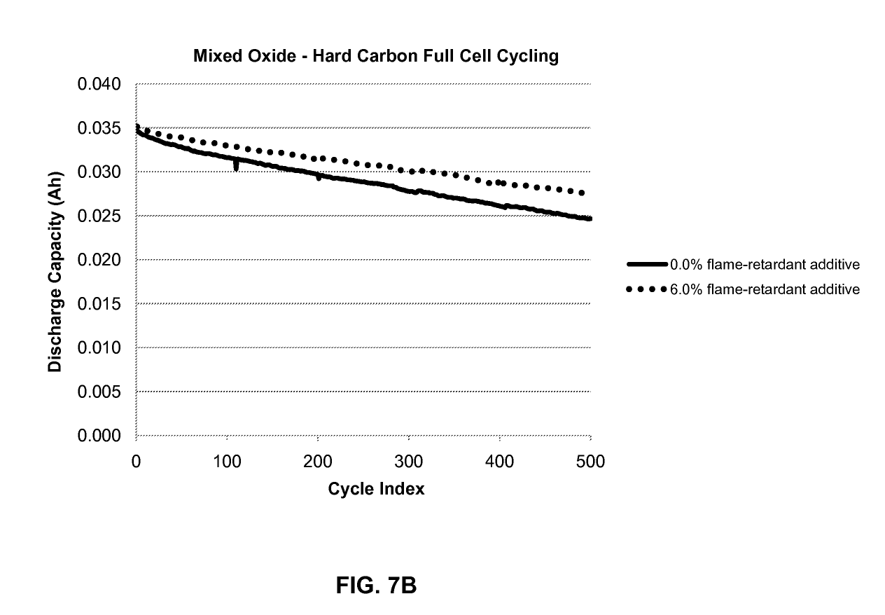

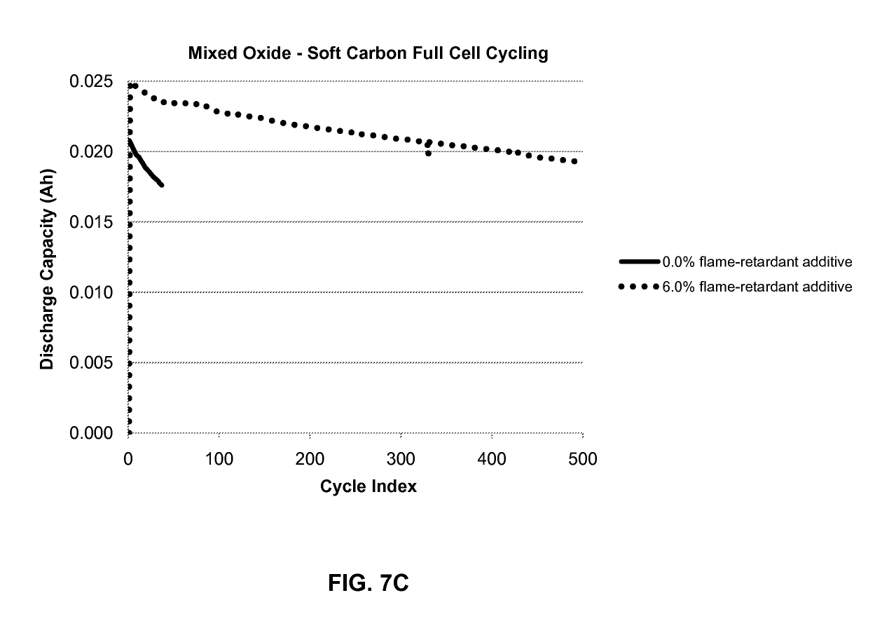

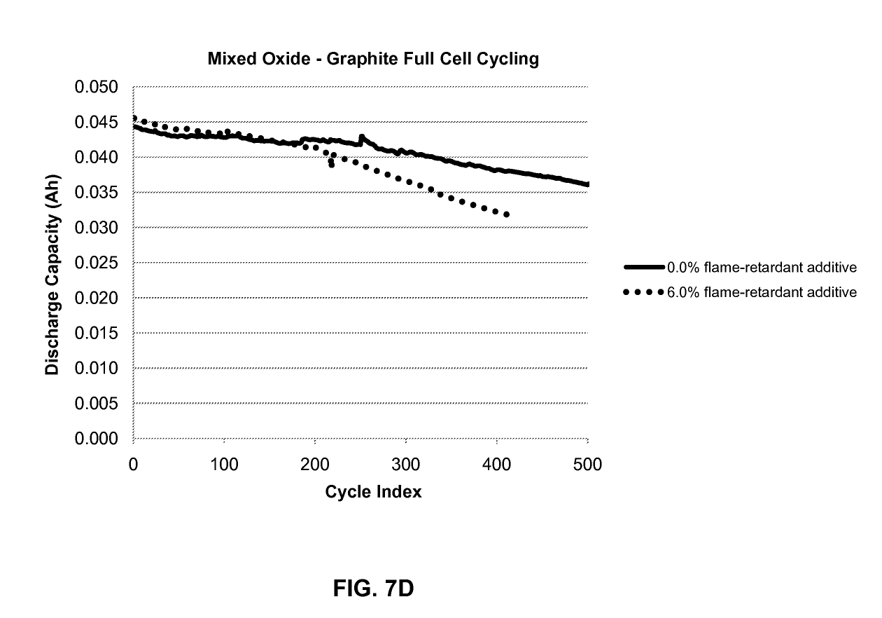

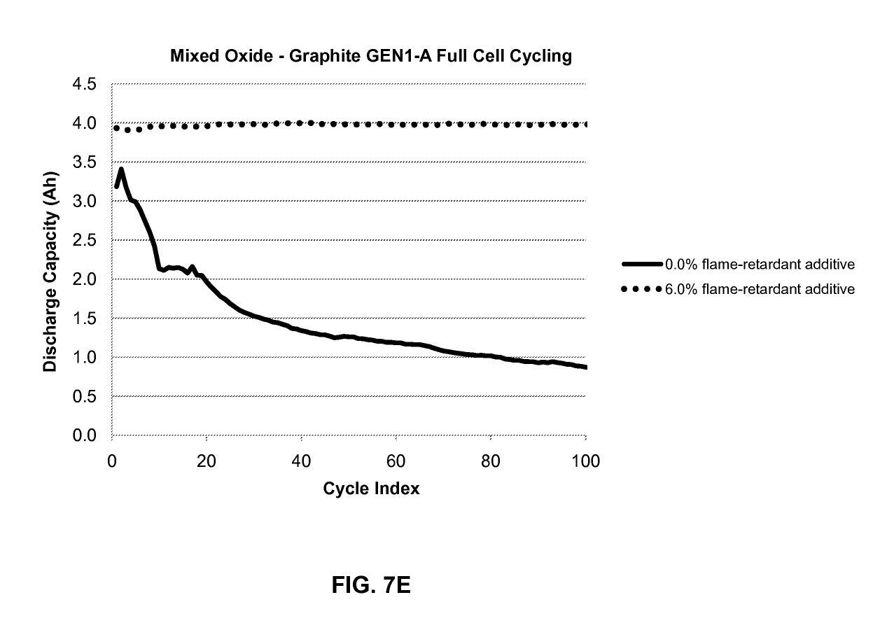

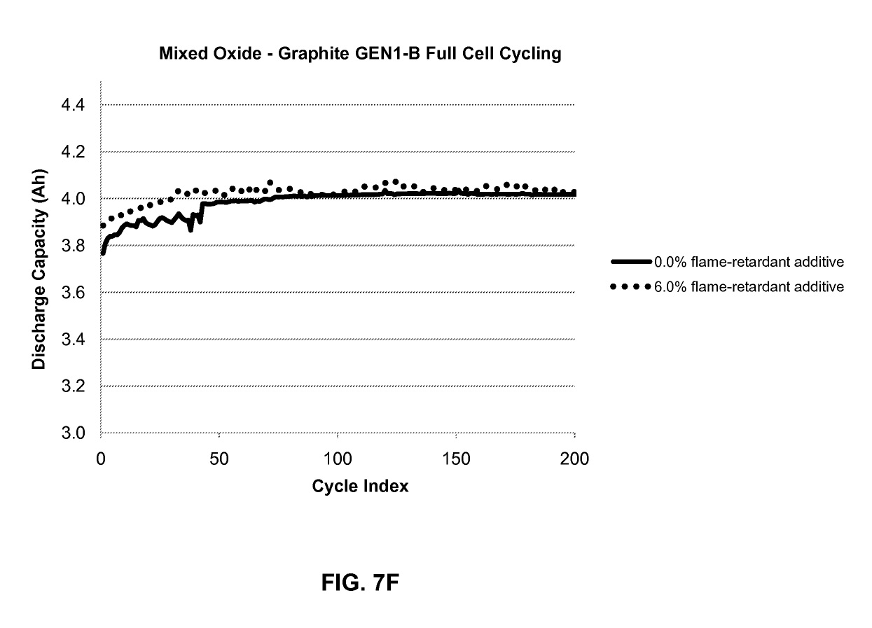

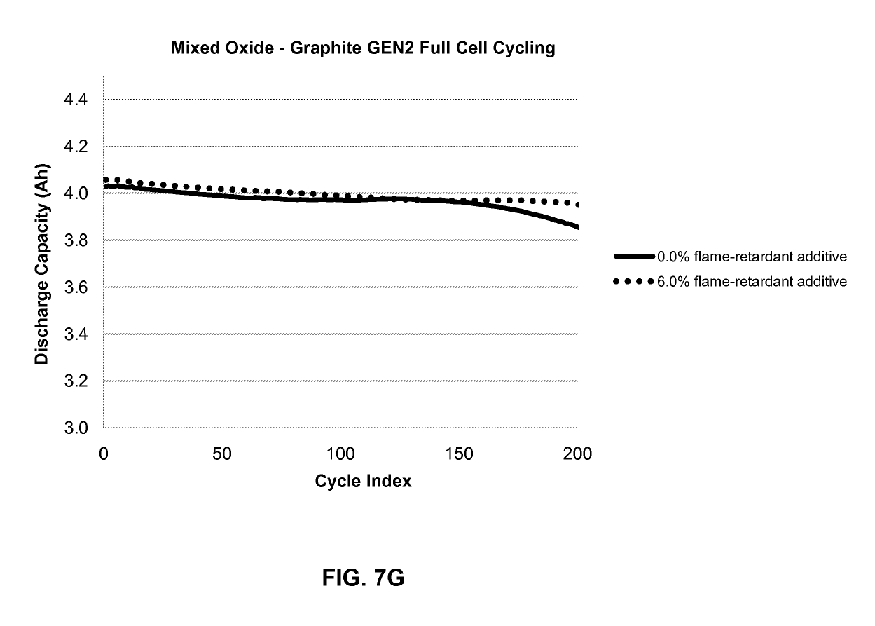

The hard carbon full cells were charged at 1 C to 4.1V with a 1 hr constant voltage charge and discharged at 1 C to 2.5V. The results are presented in FIG. 7A.

The flame-retardant additives improved the discharge capacity of the corresponding hard carbon cells during initial cycling (e.g., 0-1 cycle), early cycling (e.g., 1-200 cycles), and subsequent cycling (e.g., 200+ cycles). During early cycling, for example, the discharge capacity of the hard carbon cell having the J2 flame-retardant exceeded the discharge capacity of the hard carbon cell that lacked a flame-retardant additive. Even after 500 cycles, the discharge capacity of the hard carbon cell having the J2 flame-retardant additive continued to exceed the discharge capacity of the hard carbon cell that lacked a flame-retardant additive, at this stage by over 0.005 Ah (about 20%).

Without wishing to be bound by theory, the improved discharge capacity during initial and early cycling may indicate that the flame-retardant additive acts as a wetting agent to improve the surface wettability of the hard carbon electrodes, allowing lithium ions in the electrolyte to more easily access small, wetted pores in the hard carbon electrodes. Also, the improved discharge capacity during subsequent cycling may indicate that the flame-retardant additives develop and/or enhance a desirable SEI layer on the hard carbon electrodes.

### 5-B. Example 5-B

### Impact of Flame-Retardant Additives on Cycle Performance of Hard Carbon, Soft Carbon, and Graphite Full Cells

To evaluate the impact of flame-retardant additives on the cycle performance of different full cells, three (3) sets of full cells were assembled according to Table 3 above, the first set using hard carbon, the second set using soft carbon, and the third set using graphite as the active material on the anode.

The hard carbon full cells were charged at C/2 to 4.1 V, then at a constant voltage of 4.1 V for 1 hour, and were discharged at 1 C to 2.5 V. The soft carbon full cells were charged at 1 C to 4.2 V, then at a constant voltage of 4.2 V for 1 hour, and were discharged at 1 C to 2.7 V. The graphite full cells were charged at 1 C to 4.2 V, then at a constant voltage until of 4.2V for 1 hour, and were discharged at 1 C to 2.7 V. The results are presented in FIGS. 7B-7D.

With reference to FIG. 7B, the flame-retardant additives improved, on average, the discharge capacity of the hard carbon cells during initial cycling (e.g., 0-1 cycle), early cycling (e.g., 1-200 cycles), and subsequent cycling (e.g., 200+ cycles). These results are consistent with FIG. 7A.

With reference to FIG. 7C, the flame-retardant additives significantly improved the discharge capacity of the soft carbon cells during initial cycling (e.g., 0-1 cycle) and early cycling (e.g., 1-50 cycles). As discussed in Example 4 above, the soft carbon cells had been coated over 12 months before being tested. Without a flame-retardant additive, the discharge capacity was so low that testing was terminated after about 50 cycles. With a flame-retardant additive, on the other hand, the discharge capacity stayed above 0.015 Ah, even after 500 cycles.

With reference to FIG. 7D, the flame-retardant additives improved the discharge capacity of the graphite cells during initial cycling (e.g., 0-1 cycle) and early cycling (e.g., 1-150 cycles). However, during subsequent cycling (e.g., 150+ cycles), the graphite cells without a flame-retardant additive performed better than the graphite cells with a flame-retardant additive. In other words, the flame-retardant additives hindered the performance of the graphite cells during subsequent cycling. Without wishing to be bound by theory, the discharge capacity of the graphite cells may deteriorate when the flame-retardant additives develop a SEI layer that is too thick. SEI layers are more prevalent on graphite electrodes than hard carbon or soft carbon electrodes, which may explain why flame-retardant additives eventually hinder the performance of graphite electrodes without hindering the performance of hard carbon or soft carbon electrodes.

### 5-C. Example 5-C

### Impact of Flame-Retardant Additives on Cycle Performance of Other Graphite Full Cells

Three (3) additional sets of full cells, referred to herein as GEN1-A, GEN1-B, and GEN2 cells, were assembled. The GEN1-A, GEN1-B, and GEN2 cells were larger than the bag-type cells described above, having a rated capacity of 4 Ah. The cells included mixed oxide as the active material on the cathode. The GEN1-A and GEN1-B cells included graphite with PVDF binder as the active material on the anode, and the GEN2 cells included graphite with water-based binder as the active material on the anode. The GEN1-A cells and GEN1-B cells were similar, but the GEN1-A cells included an insufficient amount of electrolyte (e.g., 12 g), while the GEN1-B cells included a sufficient amount of electrolyte (e.g., 20 g). Flame-retardant additives were added to the baseline electrolytes of certain cells, while the baseline electrolytes of other cells were left without a flame-retardant additive to serve as the controls, as set forth in Table 5-C below.

TABLE 5-C

| | | | Flame-Retardant | |
|---|---|---|---|---|
| | Electrolyte | | Additive | |
| | Amount | | | Concentration |
| Cell Type | (g) | Active Material | Type | (wt. %) |
| GEN1-A | 12 | Graphite w/ PVDF Binder | — | 0.0 |
| GEN1-A | 12 | Graphite w/ PVDF Binder | J2 | 6.0 |
| GEN1-B | 20 | Graphite w/ PVDF Binder | — | 0.0 |
| GEN1-B | 20 | Graphite w/ PVDF Binder | J2 | 6.0 |
| GEN2 | 20 | Graphite w/ Water- | — | 0.0 |
| | | Based Binder | | |
| GEN2 | 20 | Graphite w/ Water- | J2 | 6.0 |
| | | Based Binder | | |

The GEN1-A cells were charged at 3.5 A (0.875 C) to 4.2 V, then at a constant voltage of 4.2 V for 1 hour, and were discharged at 3.5 A (0.875 C) to 2.7 V. The GEN1-B cells were charged at 3.5 A (0.875 C) to 4.2 V, then at a constant voltage until 100 mA, and were discharged at 3.5 A (0.875 C) to 2.7 V. The GEN2 cells were charged at 4 A (1 C) to 4.2V, then at a constant voltage until 100 mA, and were discharged at 4 A (1 C) to 2.7 V. The results are presented in FIGS. 7E-7G.

Without a flame-retardant additive, the GEN1-A cells of FIG. 7E never reached their 4 Ah rated capacity and cycled poorly due to the insufficient amount of electrolyte. With a flame-retardant additive, however, some of the GEN1-A cells managed to cycle at 4 Ah for 250 cycles, even with the insufficient amount of electrolyte (Note—Only the first 100 cycles are shown in FIG. 7E). This result may indicate that the flame-retardant additive acts as a wetting agent, allowing the graphite electrodes to use most or all of the available electrolyte.

With reference to FIG. 7F, the GEN1-B cells were similar to the GEN1-A cells but included an adequate amount of electrolyte (e.g., 20 g). The flame-retardant additives improved the performance of the graphite cells during initial cycling (e.g., 0-1 cycle) and early cycling (e.g., 1-200 cycles). However, during subsequent cycling (e.g., 200+ cycles), the graphite cells without a flame-retardant additive began to perform about the same as or better than the graphite cells with a flame-retardant additive. In other words, the flame-retardant additives hindered the performance of the graphite cells during subsequent cycling.

With reference to FIG. 7G, the flame-retardant additives improved the performance of the GEN2 graphite cells during initial cycling (e.g., 0-1 cycle) and early cycling (e.g., 1-200 cycles). However, during subsequent cycling (e.g., 200+ cycles), both cells exhibited a sharp decline in performance, so it is believed that the material used to manufacture the GEN2 graphite cells had degraded. In other tests with graphite cells, the flame-retardant additives eventually hindered the performance of the graphite cells, as in FIG. 7D. The same results may have been seen with the GEN2 graphite cells had the materials not degraded.

### 6-A. Example 6-A

### Impact of Flame-Retardant Additives on Electrolyte Absorption by Graphite Electrodes

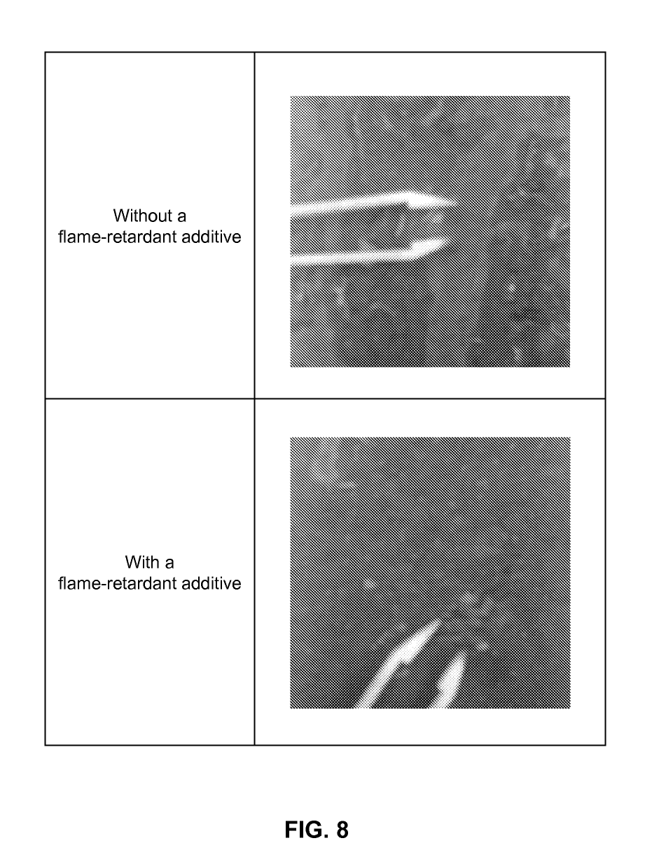

To evaluate electrolyte absorption into the surfaces of graphite electrodes, the GEN1-A graphite electrodes of Table 5-C were visually inspected after 250 cycles. The results are presented in FIG. 8.

Without a flame-retardant additive, the surfaces of the graphite electrodes appeared uneven and splotchy. The surfaces had some wet areas, which suggest electrolyte absorption, and some dry areas, which suggest electrolyte resistance. Also, chalky, white lithium dendrite formations on the surfaces were relatively large and inconsistent. These lithium dendrite formations may have contributed to the degradation of the GEN1-A graphite cells in FIG. 7E.

With a flame-retardant additive, on the other hand, the surfaces of the graphite electrodes appeared to be evenly and consistently wetted, which suggests even and consistent electrolyte absorption. Also, chalky, white lithium dendrite formations on the surfaces were relatively small and consistent, which again suggests even and consistent electrolyte absorption.

### 6-B. Example 6-B

### Impact of Flame-Retardant Additive Concentration on Electrolyte Absorption by Hard Carbon Electrodes

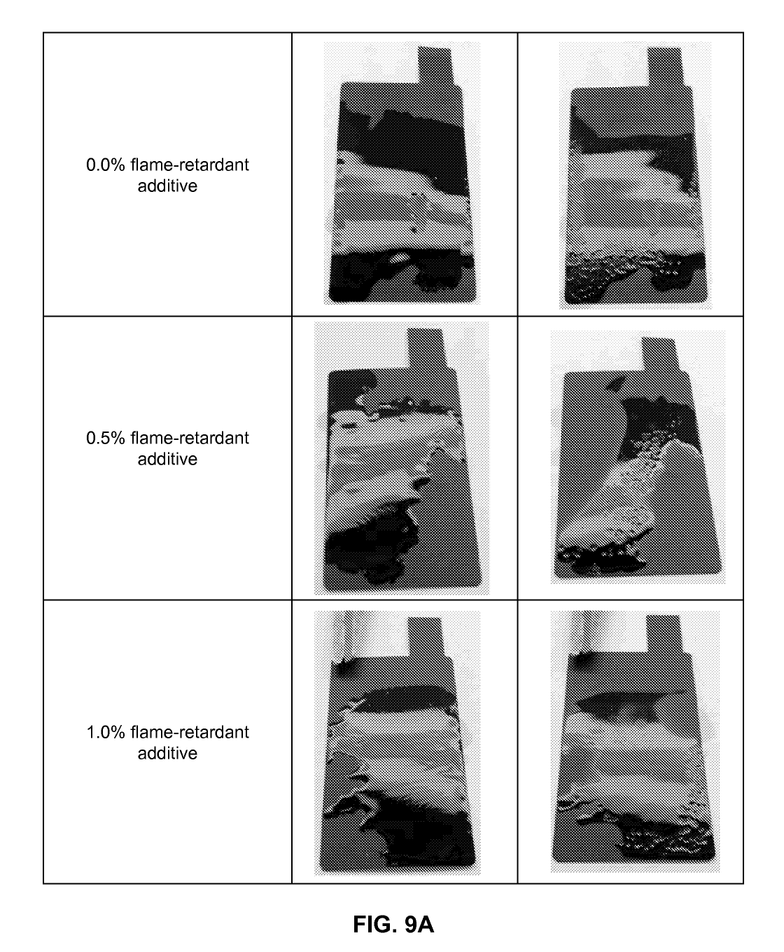

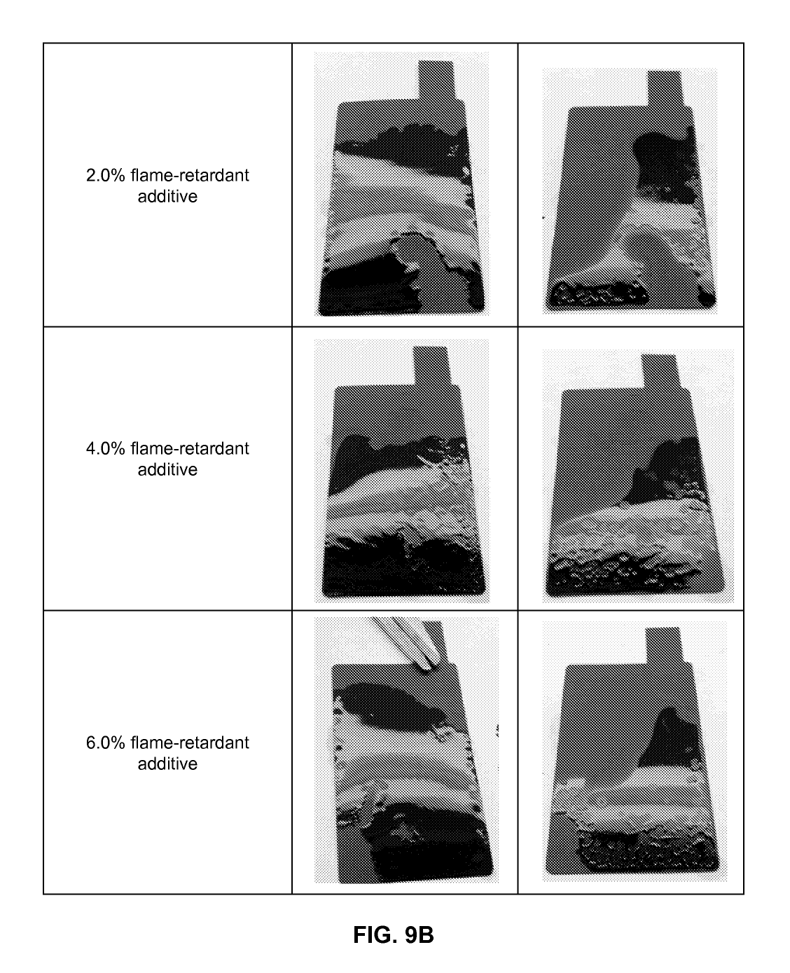

To evaluate the impact of different concentrations of flame-retardant additives on electrolyte absorption, various electrolyte solutions were prepared having the following concentrations of flame-retardant additives: 0.0 wt. %, 0.5 wt. %, 1.0 wt. %, 2.0 wt. %, 4.0 wt. %, and 6.0 wt. %. A 100 μL sample of each electrolyte solution was placed near the middle of a corresponding hard carbon electrode. A first photograph of each hard carbon electrode was taken after the electrolyte solution spread out as far as possible. A second photograph of each hard carbon electrode was taken 5 minutes later. The results are presented in FIGS. 9A and 9B.

Without a flame-retardant additive, a relatively small area of the electrolyte solution appeared to absorb into the corresponding hard carbon electrode (Compare, for example, the upper edges of the photographs corresponding to the 0.0% flame-retardant additive solution). With a flame-retardant additive, on the other hand, relatively large areas of the electrolyte solutions appeared to absorb into the corresponding hard carbon electrodes over the 5-minute time frame (Compare, for example, the upper-left corners of the photographs corresponding to the 6.0% flame-retardant additive solution).

The electrolyte solutions appeared to absorb into the hard carbon electrodes, but it is also possible that the electrolyte solutions may have at least partially evaporated from the surfaces of the hard carbon electrodes. A similar experiment may be performed taking into account the weights of the hard carbon electrodes before and after the electrolyte solutions absorbed into the hard carbon electrodes.

### 6-C. Example 6-C

### Impact of Flame-Retardant Additives on Electrolyte Absorption by Hard Carbon Electrodes

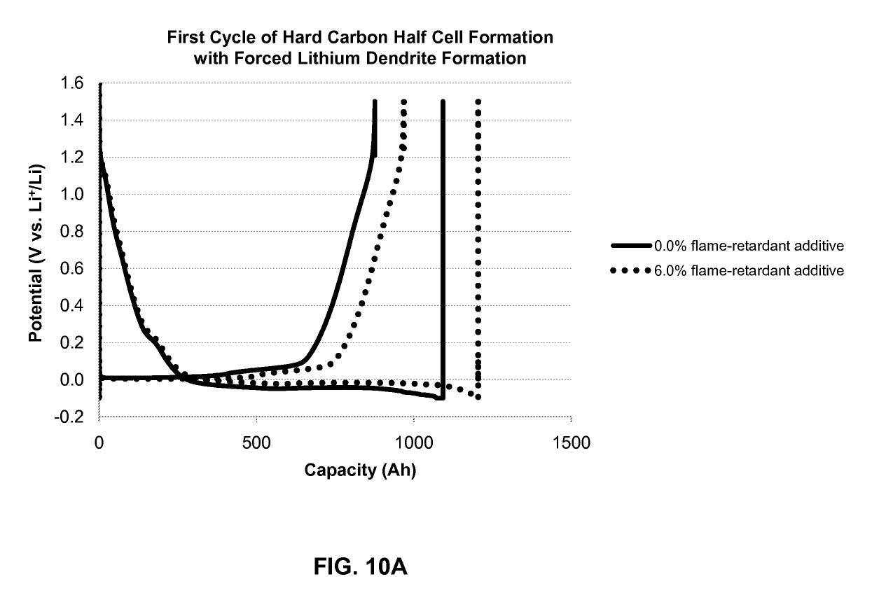

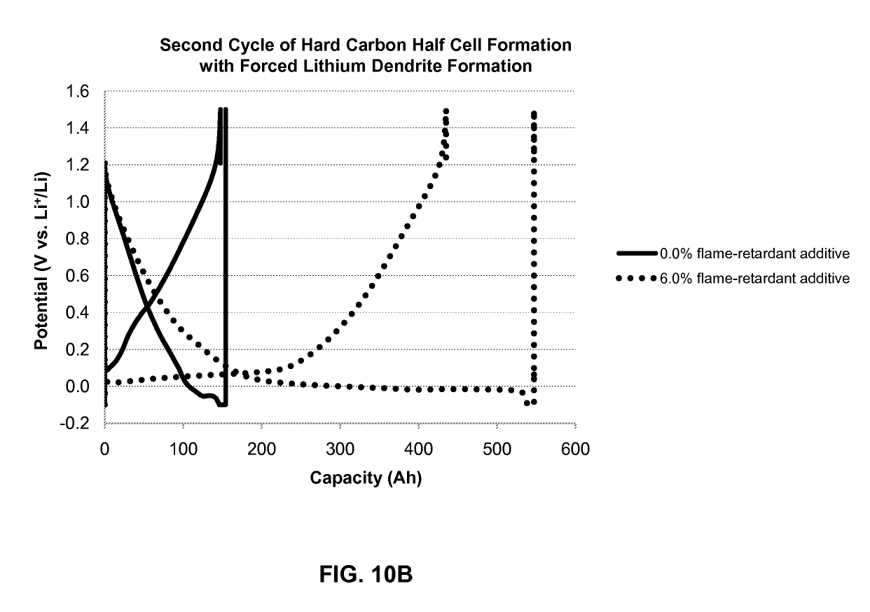

To evaluate electrolyte absorption into the surfaces of hard carbon electrodes, six (6) PVDF-based hard carbon half cells (hard carbon vs. lithium foil) were constructed, one without a flame-retardant additive and one with 6.0 wt. % of the J2 flame-retardant additive. The half cells were subjected to a forced dendrite test by driving the hard carbon voltage 0.1 V below the lithium foil voltage, which causes lithium (in the form of lithium dendrite) to plate on the hard carbon. This low voltage cycle was performed three (3) times to encourage maximum lithium dendrite formation. The results are presented in FIGS. 10A and 10B.

As shown by comparing FIGS. 10A and 10B, the cells began with high capacity. However, by the second cycle, the capacity decreased substantially due to the formation of lithium dendrites. Even with this formation of lithium dendrites, the capacity was notably higher with the flame-retardant additive than without, as shown in FIG. 10B. In other words, the flame-retardant additive allowed more of the hard carbon's capacity to be accessed. This result may indicate that the flame-retardant additive acts as a wetting agent, allowing lithium ions in the electrolyte to more easily access small, wetted pores in the hard carbon hat are not blocked by lithium dendrites.

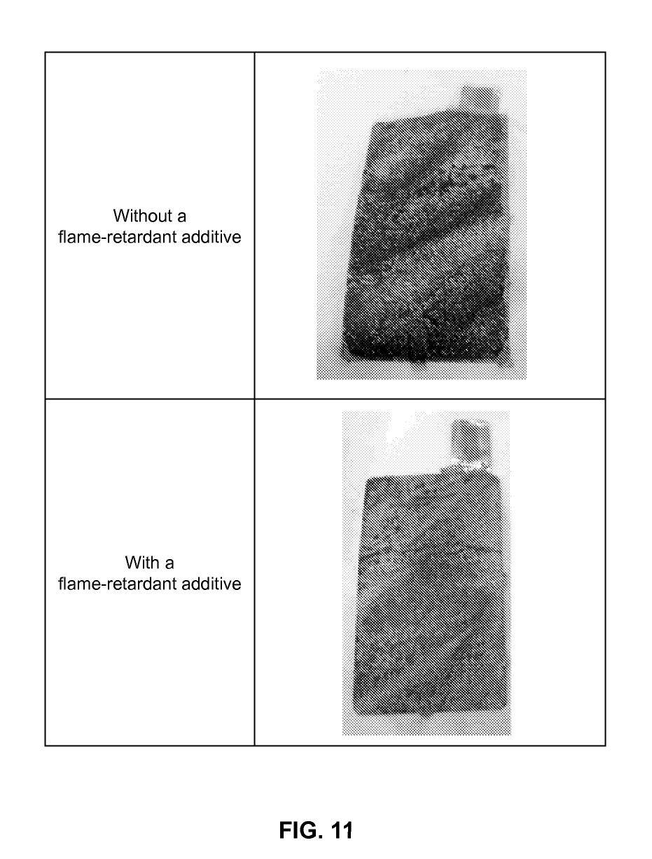

The cells were then visually inspected and the results are presented in FIG. 11. More chalky, white lithium dendrite formations were seen on the hard carbon electrode with the flame-retardant additive than without the flame-retardant additive. Again, this result may indicate that the flame-retardant additive acts as a wetting agent, allowing lithium dendrites to more easily access small, wetted pores in the hard carbon.

Even though the cell with the flame-retardant additive formed more lithium dendrites (FIG. 11), the cell with the flame-retardant additive still achieved a higher capacity (FIG. 10B) than the cell without the flame-retardant additive and with fewer lithium dendrites. Once again, this result may indicate that the flame-retardant additive acts as a wetting agent, allowing lithium ions in the electrolyte to more easily access pores in the hard carbon that are not blocked by lithium dendrites, even when a substantial portion of the hard carbon is covered by lithium dendrites.

### 7. Example 7

### Impact of Flame-Retardant Additive Type on Electrochemical Impedance of Hard Carbon Electrodes

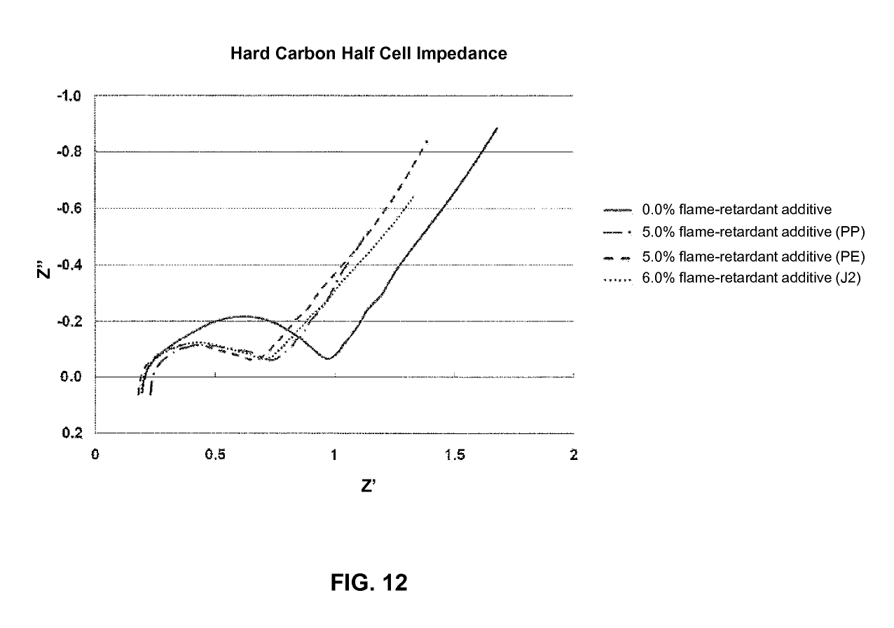

The hard carbon half cells of Table 1-A were evaluated using electrochemical impedance spectroscopy (EIS). The results are presented in FIG. 12, which displays the imaginary parts of the impedance (Z″) versus the real parts of the impedance (Z′). As shown in FIG. 12, the flame-retardant additives decreased the real parts of impedance (Z′) of the hard carbon half cells. Without wishing to be bound by theory, the present inventors believe that flame-retardant additives may decrease the impedance of the hard carbon electrodes by developing and/or enhancing a beneficial SEI layer on the hard carbon electrodes.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A lithium-based electrochemical cell comprising:
an anode comprising a disordered carbon material, the anode having a charge capacity and a discharge capacity;
a cathode;
an electrolyte in communication with the anode and the cathode; and
a flame-retardant additive that improves the performance of the anode by increasing at least one of the charge capacity and the discharge capacity of the anode.

2. The electrochemical cell of claim 1, wherein the disordered carbon material of the anode is aged before being placed in communication with the electrolyte, the flame-retardant additive rejuvenating the aged disordered carbon material of the anode to improve the performance of the anode.

3. The electrochemical cell of claim 2, wherein the disordered carbon material of the anode is aged at least about 1 month before being placed in communication with the electrolyte.

4. The electrochemical cell of claim 2, wherein the disordered carbon material of the anode is aged at least 3 months before being placed in communication with the electrolyte.

5. The electrochemical cell of claim 1, wherein the discharge capacity of the anode is measured during formation in a half cell, the flame-retardant additive increasing the discharge capacity of the anode comprising the disordered carbon material more than an ordered carbon material.

6. The electrochemical cell of claim 5, wherein the flame-retardant additive increases the discharge capacity of the anode in the half cell by at least about 3%.

7. The electrochemical cell of claim 5, wherein the disordered carbon material of the anode comprises hard carbon, the flame-retardant additive increasing the discharge capacity of the anode in the half cell by at least about 10%.

8. The electrochemical cell of claim 5, wherein the disordered carbon material of the anode comprises hard carbon, the flame-retardant additive increasing the discharge capacity of the anode in the half cell by about 30 mAh/g or more.

9. The electrochemical cell of claim 5, wherein the disordered carbon material of the anode comprises soft carbon, the flame-retardant additive increasing the discharge capacity of the anode in the half cell by at least about 5%.

10. The electrochemical cell of claim 5, wherein the disordered carbon material of the anode comprises soft carbon, the flame-retardant additive increasing the discharge capacity of the anode in the half cell by about 5 mAh/g or more.

11. The electrochemical cell of claim 1, wherein the flame-retardant additive includes a phosphorus-containing moiety.

12. The electrochemical cell of claim 11, wherein the phosphorus-containing moiety is phosphazene.

13. The electrochemical cell of claim 1, wherein the flame-retardant additive is present in the electrolyte at a concentration that is less than necessary to produce a flame-retardant effect.

14. The electrochemical cell of claim 13, wherein the concentration of the flame-retardant additive in the electrolyte is less than about 5 wt. %.

15. A method of manufacturing a lithium-based electrochemical cell having an anode, a cathode, and an electrolyte, the method comprising the steps of:
providing the anode with an active material, the active material comprising a disordered carbon material, the anode having a charge capacity and a discharge capacity; and
including a flame-retardant additive in the electrochemical cell to improve at least one of the charge capacity and the discharge capacity of the anode.

16. The method of claim 15, wherein the providing step comprises applying the disordered carbon material onto a conductive material, the method further including the step of aging the anode before placing the anode in communication with the electrolyte, wherein the including step comprises rejuvenating the aged anode.

17. The method of claim 15, wherein the discharge capacity of the anode is measured during formation in a half cell, and wherein the including step comprises increasing the discharge capacity of the anode comprising the disordered carbon material more than an ordered carbon material.

18. The method of claim 15, wherein the including step comprises increasing the discharge capacity of the anode during initial cycling.

19. The method of claim 15, wherein the including step comprises increasing the discharge capacity of the anode during early cycling.

20. The method of claim 19, wherein the including step comprises increasing the discharge capacity of the anode during subsequent cycling following early cycling.

21. The method of claim 15, wherein the including step comprises increasing absorption of the electrolyte by the disordered carbon material of the anode.

22. The method of claim 15, wherein the including step comprises adding the flame-retardant additive to the electrolyte.

23. The method of claim 15, wherein the flame-retardant additive includes a phosphorus-containing moiety.
